(19) United States
(12) Patent Application Publication
(10) Pub. No.: US 2007/0136736 A1
(43) Pub. Date: Jun. 14, 2007

(54) Spindle motor

(75) Inventor: Nam Seok Kim, Gyeonggi-do (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/637,169

(22) Filed: Dec. 12, 2006

(30) Foreign Application Priority Data
Dec. 12, 2005 (KR) 10-2005-0121754

(51) Int. Cl. G11B 19/20; G11B 17/028

(52) U.S. Cl. 720/698

(57) ABSTRACT

Disclosed herein is a spindle motor. The spindle motor includes a rotating shaft, a bearing for rotatably supporting the rotating shaft, a holder for holding the bearing, and a base unit. The base unit supports the holder to secure the holder to a predetermined position, and has shock absorbing capacity. The base unit includes a first base and a second base spaced apart from each other by a predetermined interval so that the holder is inserted into the first and second bases, and a shock absorbing member interposed between the first base and the second base.

### CROSS REFERENCE TO RELATED APPLICATION(S)

This application claims the benefit of Korean Patent Application No. 10-2005-0121754, filed Dec. 12, 2005, entitled “spindle motor”, which is hereby incorporated by reference in its entirety into this application.

### BACKGROUND OF THE INVENTION

1. Field of the Invention

The present invention relates generally to spindle motors and, more particularly, to a spindle motor, which is capable of eliminating vibration and noise generated when a disk is rotated.

2. Description of the Related Art

As well known to those skilled in the art, a spindle motor is a device which is mounted on an optical disk drive to drive a turntable, thus rotating a disk mounted on the turntable. Generally, as shown in FIG. 2, a spindle motor 200 includes a rotary unit 201 and a stationary unit 205.

The rotary unit 201 is the rotating part of the motor 200, and includes a rotating shaft 211, a rotor cover 221, and a magnet 231.

The rotating shaft 211 functions to rotate a turntable (not shown).

The rotor cover 221 serves to rotate the rotating shaft 211. A shaft fitting hole 222 is formed in the central portion of the rotor cover 221 so that the rotating shaft 211 is fitted into the shaft fitting hole 222. An oil discharge preventing piece 223 is mounted to an end of the shaft fitting hole 222 in order to prevent oil from being discharged from a bearing 215. Further, the rotor cover 221 extends in a circumferential direction, and the edge of the rotor cover 221 is bent downwards to cover a stator 235.

The magnet 231 forms a magnetic field, and is secured to an inner wall 224 of the rotor cover 221.

The stationary unit 205 is the fixed part of the motor 200, and includes the bearing 215, a holder 225, the stator 235, and a base 245.

The bearing 215 rotatably supports the rotating shaft 211.

The holder 225 holds the bearing 215 to secure the bearing 215 to a predetermined position. The bearing 215 is firmly coupled to the inner circumferential surface of the holder 225.

The stator 235 forms an electric field when external power is applied to the stator 235. The stator 235 is firmly coupled to the outer circumferential surface of the holder 225.

Further, a holding magnet 236 is coupled to the upper portion of the inner circumferential surface of the stator 235 via a back yoke 237, and holds the disk to prevent the disk from being damaged when the disk (not shown) is rotated.

The base 245 functions to support the entire motor 200. The central portion of the base 245 extends outwards, thus defining an insertion hole 246. A printed circuit board 247 is mounted on the upper surface of the base 245, and controls a signal for driving the motor 200.

However, when the conventional spindle motor constructed as described above is applied to an optical disk drive, especially to an optical disk drive adopting a DVD±RW disk, requiring high precision, the turntable may have an automatic balancing structure or a double suspension structure, obtained by increasing the weight of a deck on which the spindle motor is mounted, may be used so as to reduce vibration and noise generated when the disk is rotated. Thus, the conventional spindle motor is problematic in that the spindle motor itself cannot eliminate vibration and noise generated when the disk is rotated.

### SUMMARY OF THE INVENTION

Accordingly, the present invention has been made keeping in mind the above problems occurring in the prior art, and an object of the present invention is to provide a spindle motor, in which a base unit of the spindle motor comprises a double base structure having a shock absorbing member therein, so that the spindle motor itself eliminates vibration and noise generated when a disk is rotated.

In order to accomplish the above object, the present invention provides a spindle motor, including a rotating shaft, a bearing for rotatably supporting the rotating shaft, a holder for holding the bearing, and a base unit supporting the holder to secure the holder to a predetermined position, and having shock absorbing capacity.

In the spindle motor of the present invention, the base unit includes a first base and a second base spaced apart from each other by a predetermined interval, the holder being inserted into the first and second bases, and a shock absorbing member interposed between the first base and the second base.

The shock absorbing member is interposed at least between edges of the first and second bases.

Further, the shock absorbing member is made of polymer or rubber.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a schematic sectional view showing a spindle motor, according to the preferred embodiment of the present invention; and

FIG. 2 is a schematic sectional view showing a conventional spindle motor.

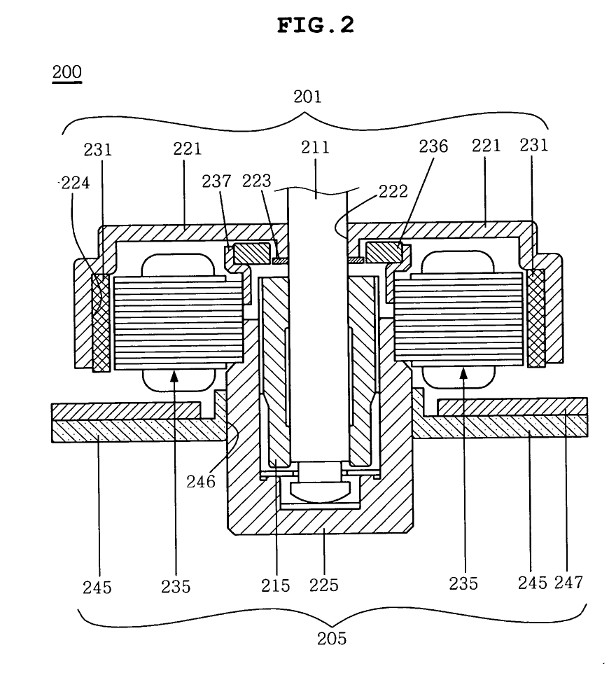

### DESCRIPTION OF THE PREFERRED EMBODIMENTS

Hereinafter, a spindle motor, according to the preferred embodiment of the present invention, will be described in detail with reference to the accompanying drawing.

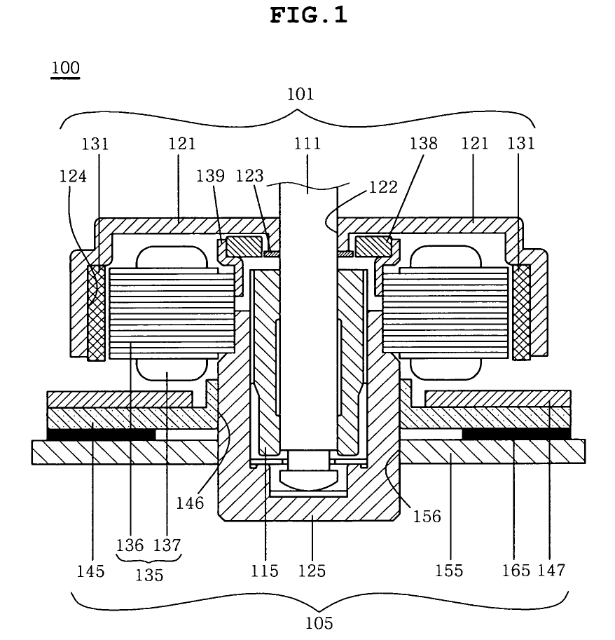

As shown in FIG. 1, a spindle motor 100 includes a rotary unit 101 and a stationary unit 105.

The rotary unit 101 is the rotating part of the motor 100, and is provided with a rotating shaft 111, a rotor cover 121, and a magnet 131.

The rotating shaft 111 rotates a turntable (not shown).

The rotor cover 121 serves to rotate the rotating shaft 111, and has a shaft fitting hole 122 formed at a center of the rotor cover 121 so that the rotating shaft 111 is fitted into the shaft fitting hole 122. An oil discharge preventing piece 123 is mounted to an end of the shaft fitting hole 122 so as to prevent oil from being discharged from a bearing 115. Further, the rotor cover 121 extends in a circumferential direction, and an edge of the rotor cover 121 is bent downwards to cover a stator 135.

The magnet 131 forms a magnetic field, and is secured to an inner wall 124 which is provided on a downwardly bent edge of the rotor cover 121.

The stationary unit 105 is the fixed part of the motor 200, which is not rotated. The stationary unit 105 includes the bearing 115, a holder 125, the stator 135, a first base 145, a second base 155, and a shock absorbing member 165.

The bearing 115 rotatably supports the rotating shaft 111.

The holder 125 holds the bearing 115 to secure the bearing 115. The bearing 115 is firmly coupled to the inner circumferential surface of the holder 125.

The stator 135 forms an electric field when external power is applied to the stator 135. The stator 135 has a bobbin 136 which is secured to the outer circumferential surface of the holder 125, and a coil 137 which is wound on the bobbin 136.

Further, a holding magnet 138 is coupled to the upper portion of the inner circumferential surface of the stator 135, that is, the bobbin 136, via a back yoke 139, and holds the disk to prevent the disk from being damaged when the disk (not shown) is rotated.

The first base 145 functions to support the entire motor 100. The central portion of the first base 145 extends outwards, thus providing an insertion hole 146. The holder 125 is inserted into the insertion hole 146 to be in close contact with the insertion hole 146. Further, a printed circuit board 147 is mounted on the upper surface of the first base 145, and controls a signal for driving the motor 100.

The second base 155 functions to support the entire motor 100 including the first base 145. A holder fitting hole 156 is formed in the central portion of the second base 155 so that the holder 125 is fitted into the holder fitting hole 156.

The shock absorbing member 165 is provided between the first base 145 and the second base 155, and is made of polymer or rubber having an excellent shock absorbing effect. In the drawing, the shock absorbing member 165 is installed partially between the first base 145 and the second base 155. In this case, the shock absorbing member 165 is preferably installed adjacent to the edges of the first and second bases 145 and 155 so as to enhance a vibration and noise removal effect. However, the shock absorbing member 165 may be installed completely between the first base 145 and the second base 155.

Although the preferred embodiment of the present invention has been disclosed for illustrative purposes, those skilled in the art will appreciate that various modifications, additions and substitutions are possible, without departing from the scope and spirit of the invention as disclosed in the accompanying claims.

As described above, the present invention provides a spindle motor, in which a base unit for supporting the motor has a double structure, that is, includes a first base and a second base, and a shock absorbing member, made of polymer or rubber having excellent shock absorbing capacity, is provided between the first base and the second base, thus eliminating vibration and noise generated when a disk is rotated.

Further, the present invention provides a spindle motor, which has a shock absorbing member, in addition to an automatic balancing structure or a double suspension structure that has been typically used, so as to eliminate vibration and noise generated when a disk is rotated, thus remarkably increasing operational precision when the spindle motor of the present invention is applied to an optical disk drive to which a DVD±RW disk, which requires high precision, is adapted.

What is claimed is:

1. A spindle motor, comprising:
a rotating shaft;
a bearing for rotatably supporting the rotating shaft;
a holder for holding the bearing; and
a base unit supporting the holder to secure the holder to a predetermined position, and having shock absorbing capacity.

2. The spindle motor as set forth in claim 1, wherein the base unit comprises:
a first base and a second base spaced apart from each other by a predetermined interval, the holder being inserted into the first and second bases; and
a shock absorbing member interposed between the first base and the second base.

3. The spindle motor as set forth in claim 2, wherein the shock absorbing member is made of polymer or rubber.

4. The spindle motor as set forth in claim 2, wherein the shock absorbing member is interposed at least between edges of the first and second bases.

5. The spindle motor as set forth in claim 3, wherein the shock absorbing member is made of polymer or rubber.
